(19) United States
(12) Patent Application Publication
(10) Pub. No.: US 2011/0101716 A1
(43) Pub. Date: May 5, 2011

(54) UTILITY POLE WITH REMOVABLE SUPPORTING PUSH BUTTON

(76) Inventors: Matthew Nolte, Hickory, NC (US); Eugene Wood, Hickory, NC (US); Michael Nolte, Hickory, NC (US)

(21) Appl. No.: 12/610,056

(22) Filed: Oct. 30, 2009

(51) Int. Cl. B25G 1/04; B25J 1/00; F16B 7/10; B25J 1/04; F16B 7/12; H02G 1/02

(52) U.S. Cl. 294/19.1; 16/429; 403/109.2; 403/109.3

(57) ABSTRACT

A lineman's pole having telescoping sections is connected by a push button assembly for temporarily fixing the length of the pole by holding sections together. The push button assembly is accessible from an end of the pole and can be installed, removed, and positioned via a connector accessible from one open end of the pole. A tool engages the connector on the push button, allowing for pulling, pushing, and rotating the button into a desired position. One connector includes a threading. A threaded tool engages the threads, allowing the user to pull the push button out of the telescoping pole. The connector, such as the threads within a bore in an adapter holding the push button, allows for removing the push button assembly. The push button assembly connects and releases cylindrical sections of the telescoping lineman's pole via openings in the surface of the telescoping sections.

### FIELD OF THE INVENTION

The invention relates to hand-held, extendible lineman's poles for attaching tools to a distal end relative to the user. The lineman's poles are useful for servicing power circuits at elevations (or depths) that are difficult to reach. In particular, the invention relates to the buttons that are used to lock extendible, telescoping lineman poles in place at selectable fixed lengths for improved safety and accuracy in using tools attached to the poles.

### BACKGROUND OF THE INVENTION

Working on a utility circuit requires highly specialized skill, training, and equipment. As would be expected, utility workers go to great lengths to ensure that utility circuits are handled safely. The market has accommodated the need for specialized safety equipment by providing utility workers with clothing (e.g. rubber and plastic garments for shock-proof attire), accessories (e.g., gloves, belts, and boots), eyewear, headwear, and hand tools that meet the needs of the profession. There are also particular machines, such as “cherry pickers,” that allow workers to access above-ground circuits. All of these developments in the utilities sector give the workers access to the circuits, allowing the public to maintain power for everyday life.

Regardless of the machines, lifts, elevators, ladders, and extension devices that are available to the utility worker for use in service applications, a power circuit is still a very dangerous installation. This danger is particularly acute during power outages when storms or accidents lead to damaged equipment that requires particular care. This is compounded by the fact that service may be necessary in the dark of night when conditions are at their worst. In many situations, the utility worker benefits from having access to good tools and the simultaneous ability to use the tools remotely (i.e., without touching the circuit or power line himself). For purposes of this disclosure, and without limiting the invention, individuals who work on utility circuits and power lines are referred to as “linemen” for reasons that the name suggests. The terms “lineman” and “linemen” are in no way limiting of either the individuals who find usefulness in the tools described in this disclosure or applications of the invention described herein.

One tool of particular interest is the lineman's pole, which gives linemen extra options in servicing installations that would be difficult or extremely dangerous to repair at arm's length. The lineman's pole is also referred to in the industry as a “telescopic pole” or a “telescopic stick” or a “telescopic hot stick”—each of which refers to the same portable, nonconductive extendible pole having a fitting for a tool at a distal end when the line worker holds the proximal end. For purposes of the disclosure herein, the term used to describe the invention is “lineman's pole.” Also, the terms “proximal and distal” are used in their ordinary meaning, and the holder/user of the pole is the reference point for each.

One particularly useful lineman's pole is set forth in U.S. Pat. No. 6,875,917 (Wood 2005), which is commonly assigned with the invention disclosed herein. The Wood '917 patent discloses the environment in which these lineman's poles are most often used. Wood states (col. 1, lines 12-34) that the “accessibility of electrical power distribution lines varies substantially because the lines are installed both above ground at various elevations and below ground in underground electric power distribution systems . . . . [A]n above ground electrical power distribution line may be 10 feet or more from the maintenance person thus requiring a pole of at least 10 feet in length to reach the line. On the other hand, a below ground electrical power distribution line may be only 5 feet or less from the maintenance person, thus requiring a much shorter pole than would be required for the above ground scenario.” The Wood patent goes on to explain that a lineman faces the choice of whether to use a variety of sticks of different fixed lengths or telescoping poles that allow for varying the length of the poles.

The Wood '917 patent discloses a portable utility power lineman's pole that includes telescoping sections that allow for varying the length of the pole for each particular use. The Wood '917 pole also includes a fitting at one end for attaching the lineman's tools that are useful in working on the circuits at issue here. Wood claims a portable utility power line pole with an alignment indicator in the form of a visible line on the outer surface of the body of the pole. The alignment line provides the user a continuous ability to visualize the orientation of each section of the pole and to predict the ultimate location and orientation of the tool at the distal end.

An early version of the lineman's pole is shown in U.S. Pat. No. 2,514,063 (Hubbard 1950). Hubbard refers to the device as a folding clamp stick and describes it as adapted for folding along its length for easy storage. The Hubbard '063 patent is adapted for receiving tools and other fittings at one end so that the clamp stick can be locked in its longest position and used to reach distant sockets.

U.S. Pat. No. 4,047,821 (Hoke 1977) shows a further development in the area of lineman's poles. Hoke discloses an elongated, lightweight, telescoping tool especially adapted for work in utility circuits. Spring loaded buttons provide releasably secure mechanisms to hold the telescoping sections together. The buttons are made of a resilient material that is resistant to shear forces and can withstand the stress of repeated engagement and disengagement from the telescoping sections.

Other telescoping implements that have also been known in the prior art for some time, include a telescoping pole and cleaning tool shown in U.S. Pat. No. 6,213,672 (Varga 2001). The Varga tool is notable as having a self-aligning tube that fits within an outer tube equipped with a guide slot. The tubes are held together with a snap button that must be aligned with respective holes in the tubes so that the telescoping tubes stay in place. Even with so many telescopic poles available in the prior art, individuals continue to consider ways of improving their uses and versatility. See, e.g., U.S. Patent Publication No. 20040189028 (Newman 2004)(disclosing a telescoping implement with a fitting at the far end for changing light bulbs).

In the utility sector, prior art telescopic line sticks include not only the Wood '917 device noted above, but also devices from other companies, such as Hastings Inc. and Hubbell Power Systems, Inc. These companies, along with Utilities Solutions, Inc., sell lineman's poles that are useful in performing utility work from ground level. Typically, these devices are fiberglass telescoping sections that lock together with button assemblies. As shown in more detail in the drawings denoted herein as prior art, a universal spline end allows the linemen to attach tools for engaging switches, opening enclosures, installing hardware, and performing tasks that are necessary to maintain utility service.

Hastings Fiber Glass Products, Inc. is, at present, the assignee of U.S. Pat. No. 5,593,196 (Baum 1997) disclosing a telescoping hot stick, or pole, for manipulating a tool from a distance. The hot stick includes a tubular first section having a female end and a noncircular cross sectional shape. The second telescopic section fits within the first, but the noncircular cross section prevents displacement at the perimeter and requires no maneuvering for proper alignment among the sections. A lock button holds the telescoping sections together. The second section may be held in the extended position but still connected to the first section even when sliding the telescoping sections back and forth. The sections can be removed from one another by depressing the lock button and sliding sections out.

Telescoping poles used in numerous applications have been known for quite some time. As noted above, these devices are often held together by a button assembly. The sections are equipped with proper openings that allow the button assembly to pop into place and hold the telescoping sections together at the holes. A recurring problem in these telescoping lineman's poles is that the button assemblies face significant wear and tear due to repetitive engagement and disengagement with the holes of the sections. Another problem is that the button assemblies are difficult to replace without disassembling the whole unit. As the sections of the unit slide within one another, the button assembly within the most distal section can be accessed only by removing the telescoping sections that are closer to the user.

The prior art does not address the accessibility of the buttons for installation or replacement. The button assemblies have been the subject of developments, however. U.S. Pat. No. 5,729,865 (Stoddart 1998) shows a telescoping assembly pole with an outer tube, an inner tube slidably received within the outer tube, and a slide button that moves parallel to the longitudinal axes of the inner and outer tubes. The button assembly includes a locking mechanism with a biased slide button and a locking pin for retaining the tubes in an adjusted (most likely extended) position.

Continuing with developments in the button assemblies for telescoping sections, U.S. Pat. No. 6,050,531 (Wilcox 2000) discloses a locking device for multi-section telescoping tubes and includes a mechanism for locking the telescoping tubes in any extended position. A push rod releases a pin or ball that clamps the internal surface of an outer section to the surface of an inner section. The pin or ball prevents the inner leg from sliding within the outer leg.

U.S. Pat. No. 6,925,686 (Heathcock 2005) discloses a twist lock assembly having sections of telescoping legs connected by rotational assembly. The rotational movement interlocks two pairs of axially spaced apart tabs and recesses. The assembly may also include a grip section, a pole section, and an accessory attachment. Heathcock, therefore, attempts an improvement on the latching mechanisms of telescoping pole sections by twisting the sections and moving a tab to a corresponding recess in the overlying assembly. Still, however, any repairs to the tab require full disassembly of the unit from the outside section inward.

The button and locking assemblies used to attach telescopic pole sections have also been the subject of international efforts. International Patent Application No. WO 2002051562 (Haas 2002) discloses a lock for securing first and second telescoped pole sections connected by a collar there between. The collar is adapted to be radially constricted by a lever accessible from the surface of the outer telescopic section.

International Patent Application WO 20090398578 (Wright 2009) shows an internal locking device for a telescopic extendible pole of the type comprising an inner and outer telescoping section and a stop on the outer section to prevent separation upon maximum extension of the sections. The Wright '578 device includes a mechanical locking means on the interior of the outer telescopic section. As noted in prior devices, this interior arrangement is difficult to repair upon failure, as it requires entire disassembly of the entire unit.

Another telescoping lineman's pole of the prior art is shown schematically in FIG. 1 of this disclosure. The telescopic lineman's pole (10) included in this drawing is adapted for fitting a universal adapter, known as a universal spline end (12). The universal spline end (12) is a conventional attachment for releasably engaging specific tools that are useful for servicing a utility line or a utility installation such as a transformer.

One problem that arises in prior art lineman's poles is that the button assembly (13) connected to the last telescopic section (i.e., the section connected to the universal spline end (12)) eventually breaks over time due to repetitive use. Unfortunately, to access the final telescopic section and its locking button (13), the entire telescopic pole (10) assembly must be disassembled, usually from the most proximal end relative to the user (i.e., the user slides each section out from the largest diameter bottom section). This is a highly inefficient system of repair, and often the whole pole is replaced instead of the single button being repaired. In that case, a simple button assembly malfunction leads to the cost of an entirely new lineman's pole.

The cross sectional drawing of FIG. 2 shows another prior art telescopic lineman's pole section (17) with no access to the button assembly (18) for repair. The telescopic section (17) has a glued and pinned universal spline end (12) at the most distal end of the lineman's pole. The glue (19) eliminates the option of removing the button assembly from the tip even if the universal spline end (12) is taken out. Clearly, the universal spline end (12) of FIG. 2 is not meant for removal. On the opposite side of the button assembly, toward the lower or proximal end of the lineman's pole, insulation (20) prevents access to the button assembly. It is very common for lineman's poles, including those described for purposes herein, to be insulated for safety. The insulation within the lineman's pole prevents access to the pole for installing or removing the button assembly.

FIG. 3 shows yet another prior art lineman's pole (22) having a button assembly (23) for holding sections of the telescoping pole (22) together. In FIG. 3, the universal spline end (12) is pinned for security, but it is ultimately removable. After all, the inside of the pole section is threaded (24), and the universal spline end (12) is threaded. Unfortunately, this model does not allow for replacing the button assembly (23) because the threading prevents the button from being removable. The button assembly (23) simply does not fit through the end of the pole, so the user can not remove the old or install a new push button from the far end of the pole. Again, the insulation (20) blocks access from the end of the telescoping section opposite the spline end.

FIG. 4 shows a universal spline end (27) that caps the end of the lineman's pole (28) and therefore leaves ample room to slide the button assembly (29) out of the end when the universal spline end (27) is removed. The problem, however, is that even with this arrangement, the button assembly (29) has no mechanism for pulling the button assembly out of the telescoping section without breaking the pole section in two. The device provides no means of grasping the button assembly (29) from the inside of the telescoping pole (28). By using a capping spline end (27), the user may be able to install a push button assembly by sliding the assembly, with the push button therein, down one end of the pole. A screwdriver recess in the top of the push button assembly may even allow for rotation of the push button assembly to push the button out of an associated recess. The setup of FIG. 4, however, allows for no convenient mechanism or access to remove the push button assembly (29) from either the far end of the lineman's pole or from the insulated (20) lower portions of the sections.

The prior art, therefore, shows telescoping pole assemblies, and other efforts have attempted to improve the button and locking assemblies that hold the sections together in a releasable way that allows for the pole sections to slide and adjust the length of the pole. None of these earlier developments, however, has shown a button assembly that can be easily accessed for replacement upon failure. Accordingly, the invention herein addresses this need in the art.

### SUMMARY OF THE INVENTION

A portable utility lineman's pole has at least one inner section and at least one outer section fitting together in a telescoping configuration, wherein the sections define respective inner section surface openings and outer section surface openings along the length of the pole. The pole includes a push button engaging at least one of the sections through at least one surface opening in the section, and the push button includes a connector for adjusting the position of the push button from an end of the lineman's pole. The connector may be a gripping mechanism for removing the push button from one end of the pole, for controlling the push button while sliding the push button into an end of the pole, and for rotating the push button within the pole. The connector may be a threading that attaches to an associated tool for holding the push button while installing, removing, or positioning the push button in the device. The connector may also be a ring, a loop, a groove, a tab, or any other kind of connector that allows the user to manipulate the push button outside the pole and inside the pole.

In one embodiment, the invention is a portable utility lineman's pole having telescoping sections connected by a push button assembly for temporarily fixing the length of the pole by holding sections together in the telescoping configuration. The push button assembly is accessible from the distal end of the pole section that it holds in place. The push button assembly can be adjusted for installation and removal by gripping, engaging, or attaching to a connection element that is part of the push button assembly. In one embodiment, the connection element is a threading within the push button assembly. The threading may be integral to an adapter that holds the push button in place within the lineman's pole. In this embodiment, the user reaches the threaded adapter with a threaded tool that engages the adapter threads, allowing the user to attach the push button assembly to a threaded tool for installing the push button assembly into one end of the pole, or, in the alternative, the user connects to the threading to pull the button assembly out of the telescoping pole. The threads within a bore in the adapter provide a grip for accessing and removing the button assembly. A different button assembly can be attached to the threaded tool to assist in sliding a new push button assembly down into the end of the pole. The connection element, therefore, assists in removing and installing push buttons from one end of the device without taking the whole lineman's pole apart. In other embodiments, the connection element used to manipulate the push button assembly can be a tab, a ring, a loop, or any connecter that is amenable to gripping the push button assembly. A corresponding tool (e.g., a tool with a clamp, jaws, pliers, or hook) attaches to the push button assembly via the above described connection element for installing the push button assembly down into the pole or for pulling a broken push button assembly out of the pole.

The push button assembly disclosed herein connects and releases cylindrical sections of the telescoping lineman's pole via openings in the surface of the telescoping sections. In one embodiment, the push button assembly is held together by an adapter defining a connection element for manipulating the push button assembly from one end of the pole. The connection element may be a threaded hole or bore in the adapter and is accessible through an end of a first cylindrical section of the telescoping lineman's pole. Otherwise, the connection element can be the tab, ring, loop or similar engagement point as discussed above. The connector may be any engagement point that is useful for controlling movement and position of the push button through an end of the pole, including recesses and grooves that attach to a tool fitting within the lineman's pole.

In one exemplary use, a push button extends through an adapter and through corresponding openings in at least one section of the telescoping lineman's pole. As the pole telescopes to varying lengths, the push button may engage more than one section of the pole through surface openings along the length of each section. The push button and the push button assembly, therefore, hold the sections together. By depressing the push button through the corresponding openings in two mated telescoping sections, the push button compresses a spring and allows the sections to slide over each other. The spring biases the push button to resiliently allow the push button to move back into place through the openings in the sections when the user decides to extend the telescoping assembly.

The telescoping lineman's poles having the aforementioned push button and push button assembly are more conveniently maintained when used in combination with a tool that reaches into an open end of a telescoping lineman's pole, engages the push button and/or the push button assembly, and with the push button depressed to its most interior position within the inner diameter of the innermost telescoping section, allows for pulling an entire push button assembly out of the pole. Similarly, the push button assembly may be installed into a telescoping lineman's pole with the same tool. In an exemplary embodiment, the push button assembly includes a threaded bore. By threading the push button assembly onto the tool, the user pushes the entire push button assembly into the lineman's pole such that the push button is secured within corresponding openings in the pole sections. With the push button assembly in a locked position, the threaded tool is detached from the push button assembly. The same threading may be used to remove the push button and the push button assembly from an end of the lineman's pole without disassembling the entire device.

### BRIEF DESCRIPTION OF THE DRAWINGS

FIG. 1 is an illustration of the prior art showing the most distal section of a telescopic lineman's pole having a push button assembly and a universal spline end attached thereto.

FIG. 2 is a cross sectional view of the telescopic pole section of FIG. 1 and again shows the prior art having a push button assembly positioned between an insulation filled pole section and a glued and pinned universal spline end attached to the opposite end.

FIG. 3 is a cross sectional view of a prior art telescopic pole having an inaccessible button assembly due to the assembly being surrounded by insulation and a pinned universal spline end.

FIG. 4 is a cross sectional view of a prior art telescopic pole allowing access to the button assembly without any way of retrieving it from the telescopic section housing the button assembly.

FIG. 5 is an exploded view of the push button assembly of this invention held in place by a threaded adapter that is removable via a correspondingly threaded tool.

FIG. 5A is an exploded view of the telescoping pole of this invention having a universal spline end with dual bores for alignment with the visible line on the pole.

FIG. 6 is an assembled view of the most distal telescopic section of a lineman's pole according to this invention.

FIG. 7 is an exploded view of an overall lineman's pole according to this invention.

FIG. 8 is an assembled view of the extended lineman's pole having attached sections according to this invention.

### DETAILED DESCRIPTION

The lineman's pole, described in more detail below, can be viewed from the perspective of the lineman using the pole. From this perspective, the lineman's pole has a “proximal” end closest to the lineman and a “distal” end farthest from the lineman. The distal end, therefore, is typically the end that a lineman ultimately manipulates remotely to adjust an overhead or underground circuit that cannot be reached by hand. The proximal end is often the end having the telescoping section of the greatest diameter and allows the lineman to grip the pole with a steadier force than a thinner diameter would allow. One goal, of course, is to provide a pole that can be used with precision on a circuit element that is a significant distance from the user. After all, the most distal point on a lineman's pole will be used to replace the dexterity of a human hand in working on a circuit element.

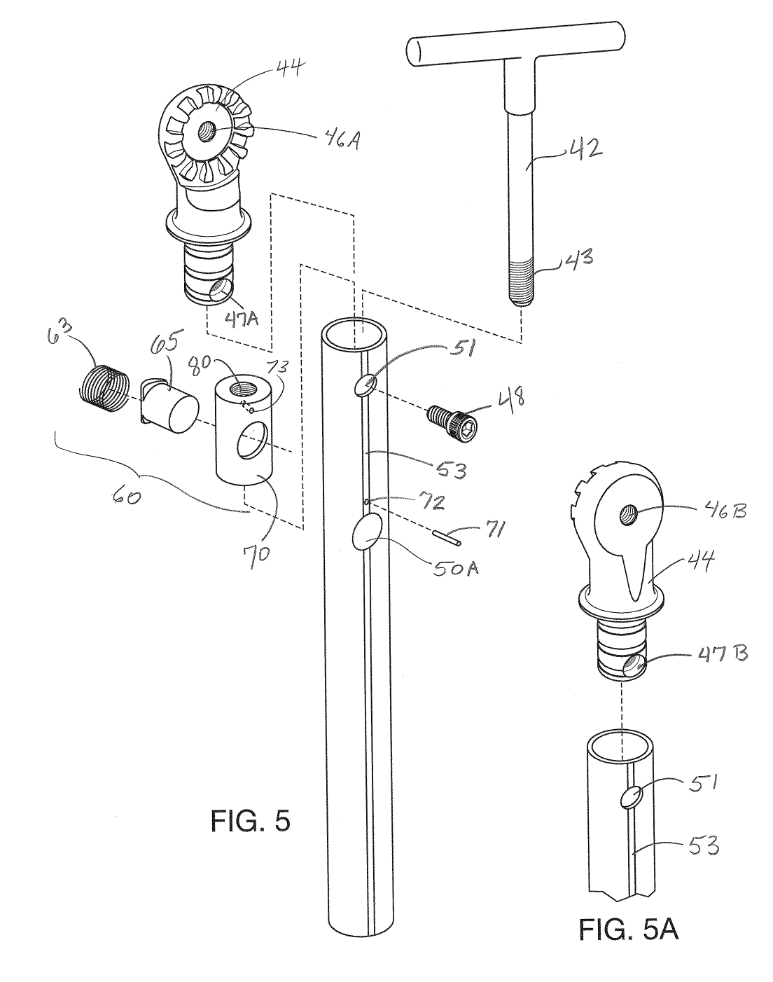

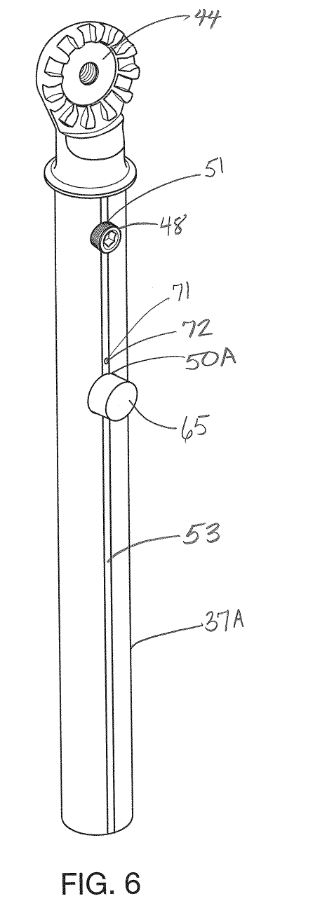

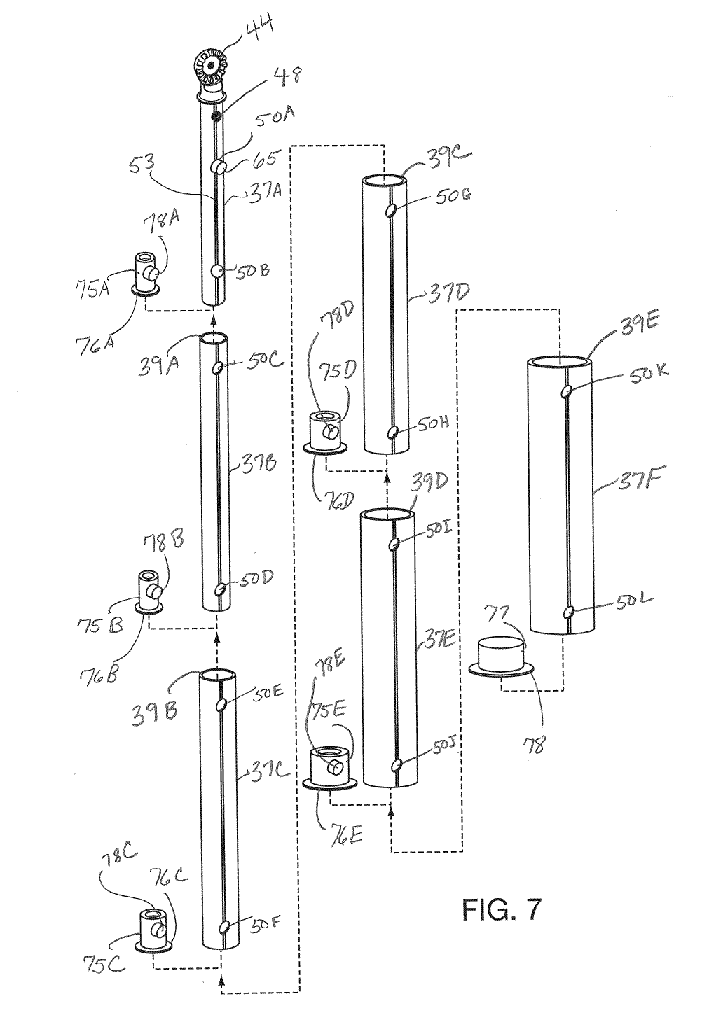

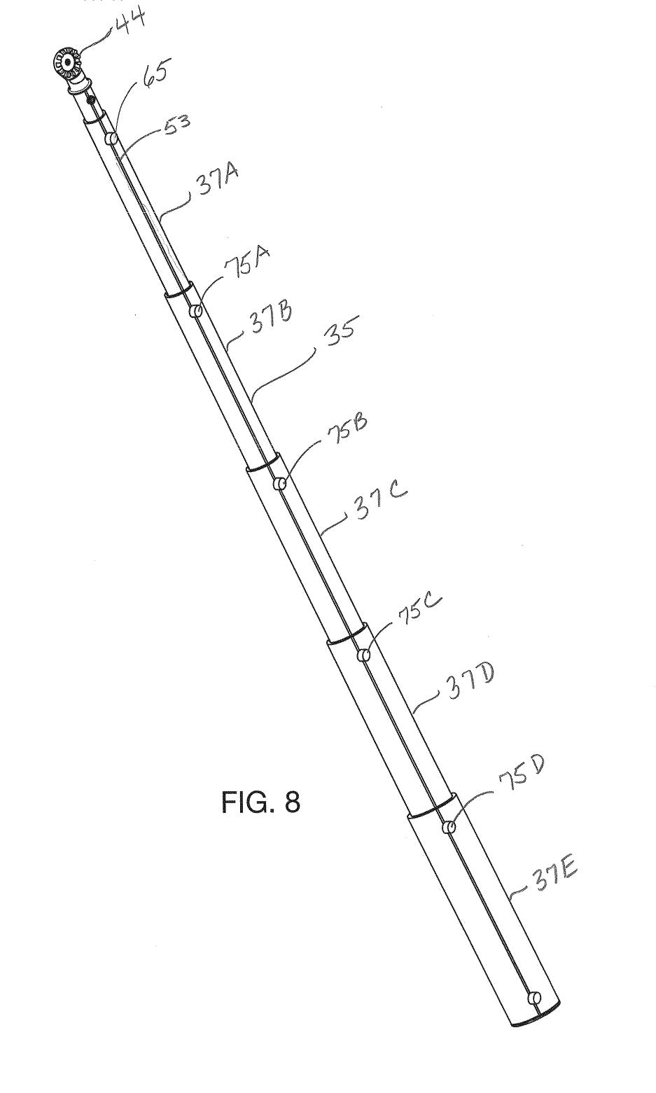

The lineman's pole (35) shown in the figures consists of sections (37A-37E) that telescope together to form a “stick” with a varying length. For purposes herein, two adjacent sections that are in a direct telescoping relationship may be referred to as an “inner section” (e.g., 37A) and an “outer section” (e.g., 37B) to convey a description of the way one section of the lineman's pole slides into a next larger section of the lineman's pole. The number of sections in a lineman's pole may vary depending on the user's preferences, and any two adjacent sections may be designated as inner and outer sections without changing the nature of the parts of the lineman's pole described herein. Typically, one section slides into an immediately adjacent section of larger diameter. The sections stay together to form an extendible pole. One way to connect the sections is by using locking mechanisms (75) that engage the distal end of a larger diameter, outer section and the proximal end of a smaller diameter, inner section. The distal end of each section in a pole may form a respective rim (39) that essentially plugs the distal end of the larger section onto a locking mechanism (75) that also attaches to the proximal end of the next inner section. FIG. 7 shows an exploded view of a lineman's pole that incorporates the rims (39A-39E) of the pole sections, the locking mechanisms (75A-75E), a base ring (76A-76E) on each locking mechanism, wherein the base ring (76A-76E) engages the fitting lips, or rims (39A-39E), on the pole sections (37A-37E). The contact between the base rings (76) on the locking mechanisms (75) and the rims (39) on the pole sections allows for full extension of pole sections without detaching the sections. The locking mechanisms also incorporate push buttons (78A-78E) for engaging surface openings in the pole sections. To avoid confusion among the various push buttons described herein, the push buttons within the locking mechanisms are referred to as “lock buttons,” and the primary push button at issue here is the detailed push button (65) and push button assembly (60) shown in FIG. 5.

This disclosure refers to a push button as a part of a push button assembly (60). The drawings show non-limiting examples of the push button (65) as a separable, discrete part within the overall push button assembly (60). It is entirely within the scope of this disclosure, however, for the push button assembly to be integrally formed with the push button so that the entire assembly essentially makes up an overall “push button” with no removable, separable parts. Accordingly, the terms push button and push button assembly may be used interchangeably in certain contexts.

The lineman's pole (35) set forth herein includes a new push button assembly (60) that allows for the push button assembly to be installed into a lineman's pole from one end, maneuvered within the pole from that same end, and removed and replaced from that end of the lineman's pole as well. For purposes herein, there is a distinction between the push button assembly (60) of this invention (e.g., FIG. 5) and traditional locking mechanisms (75A-75E) used in the prior art. The push button assembly (60) set forth in this disclosure is shown in relation to the end of the most distal section of the lineman's pole. In this position, the push button assembly (60) may be used to configure the lineman's pole in a “tip lock” orientation. Without limiting the invention, the tip lock orientation allows for the last, or most distal, inner section (37A) of the lineman's pole (35), to be retracted down into the next overlying section (37B) so that only the tip of the inner section (37A) and its spline end (44) protrude from the outer section (37B). This position reinforces the strength of the distal end of the lineman's pole for better maneuvering in the field. In one embodiment, the invention described below, therefore, relates to the push button assembly (60) closest to the spline end (44) attached to the lineman's pole (35). The user, however, has the option of extending the lineman's pole out of the tip lock position to fully extend the pole. With the pole in its fully extended state (i.e., out of the tip lock position), the push button assembly (60) of this invention may not connect another section.

For ease of reference only, and without limiting the invention disclosed herein, push buttons used along the remaining length of the lineman's pole, other than the tip lock end, are referred to as “locking mechanisms (75A-75E).” See FIG. 7. The push button assembly (60) claimed below and shown in FIG. 5 includes push button (65), while the buttons used in the “locking mechanisms” are referred to herein as lock buttons (78A-78E). This distinction is used only for discussion purposes, and the technology set forth in regard to the push button assembly (65) could be transferred and used to hold other sections of the same telescoping lineman's pole. In other words, the push button assembly (60) and push button (65) could be used in conjunction with the locking mechanism (75) and lock buttons (78).

The push button assembly (60) used in a portable telescopic lineman's pole (35) according to this invention allows for the telescopic pole (35) to be locked in more than one configuration. Referring to FIG. 7 again for an overview, the lineman's pole (35) includes numerous sections (37) that fit together in a telescoping configuration, one inside the next. The sections (37A-37F) define openings (50A-50L) in the surface (i.e., surface openings) of the sections for a locking mechanism (75A-75E), or push button (65), to engage. As shown in FIG. 7, in one configuration, each section locks to the next with locking mechanism (75A-75E) that includes a lock button (78A-78E) that engages a hole, or surface opening (50) in that section. By moving the sections (37) in relation to one another, the same lock button (78), or the push button assembly (65) of this invention, engages a corresponding hole (50) in the overlying telescoping section (37). The locking mechanisms (75) and/or the push button assembly (65) hold the sections together.

The telescoping sections (37) of FIG. 7 utilize locking mechanisms (75) to lock the sections in an extended, but retractable, telescoping relationship. The locking mechanisms (75) connect to the bottom of an inner section (e.g., 37A) of the telescopic lineman's pole (35). The locking mechanism (75) is further connected to the top of an adjacent outer section (e.g., 37B) to hold the sections in place. The locking mechanisms each include a respective resilient lock button (e.g., 78A) adapted for engaging and disengaging corresponding holes (50A-50L) on the surface of the telescoping sections. The telescoping sections have alignment indicators (53) visible on the outer surface to easily match the holes (50) for locking in place. This feature is shown in detail in U.S. Pat. No. 6,875,917. With the numerous sections available, the telescoping lineman's pole is readily set to various lengths, depending upon the use at hand. The locking mechanism further includes a base ring (76B) around one end of the locking mechanism for engaging an open end of connected inner and outer pole sections. The base ring (76) engages a lip, or ring (39) extending about the ends of the sections.

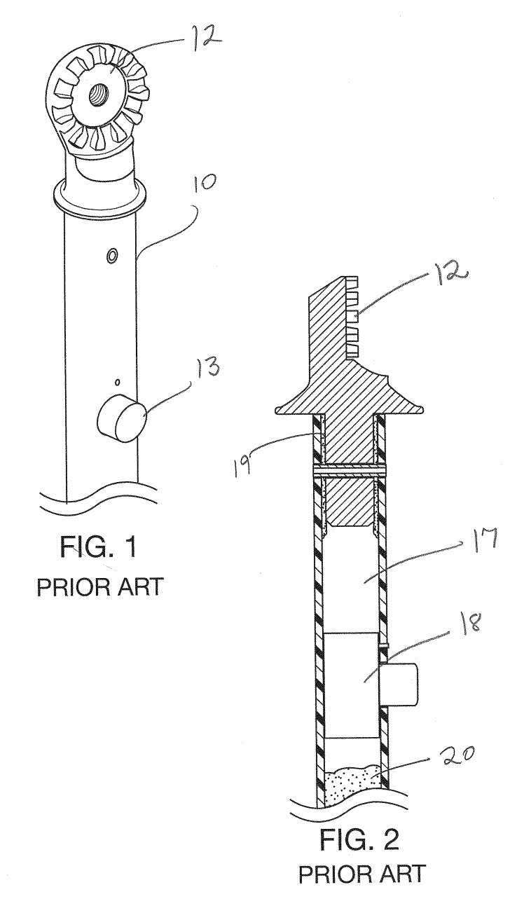

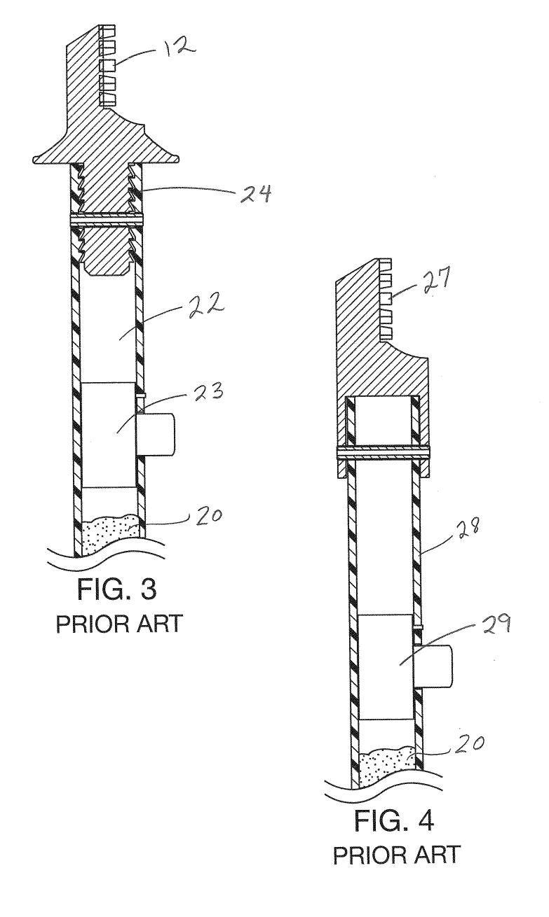

When used by a lineman, the pole (35) can be described as having a proximal telescoping section (e.g. 37F) closest to the lineman using the pole and a distal section (e.g., 37A) at the opposite end. As shown in the prior art drawings (FIGS. 1-4), the distal end connects to a universal spline end (44) or another attachment for engaging a tool used by the lineman. The universal spline end (44) may include teeth for attaching to a lineman's tool, and corresponding bores (46A, 46B) for further attachment possibilities. By aligning one of the bores to the visible line (53) on the pole sections, the user can always know the orientation of the spline end (44) when used in dark situations or conditions with low visibility. In this way, the dual bores (46A, 46B) allow for tools to be attached more quickly and allow the user to manipulate the tools more efficiently without spinning the pole about its longitudinal axis to figure out on which side the spline end is attached. The most proximal section of the pole from the perspective of the user includes an end cap (77) that fills the end of that section. The spline end (44) may be connected to the pole by pinning or by threaded screws (48) fitting into threaded bores (47A) in the spline end (44). Accordingly, the lineman's pole (35) includes pin holes and screw holes (51) for such purposes.

The most distal section, referred to as an inner section (37A), also includes a second mechanism referred to herein as a push button (65), possibly included within a push button assembly (60), that allows for a tip lock position among adjacent pole sections. The tip lock position is generally described as a way of reinforcing the stability and strength of the section (37A) holding the universal spline end (44). To accomplish this added stability, the most distal section (37A) of the lineman's pole (35) slides into the next lower section (37B) which is of a sufficient diameter to overlie the most distal section (37A), shortening the overall length of the pole, but ensuring that the tool attached to the end of the pole has the reinforced strength of two telescoping sections making the end of the pole stiffer for the lineman to use.

In the tip lock position, the lock button (78) of the most distal section slides into the next lower section. The locking mechanism (75) of the most distal section is depressed and slides into the next lower section without engaging a surface opening. The base ring (76) around the lower perimeter of each locking mechanism (75A-75E), slides down into the next larger diameter, more proximal section. The push button assembly (60) included within the most distal section engages the surface opening (50A) at the far end of the most distal section (i.e., the end closest to the universal spline end and the associated lineman tool). In this position, the push button is accessible to move up and down as necessary to allow the most distal telescoping section to slide within the next lower section. As noted in the above mentioned U.S. Pat. No. 6,875,917, the lineman's pole has a visible line (53) indicating the position that the sections must be aligned to for the surface openings to match.

In the tip lock position, the push button assembly (60) engages the surface opening (50C) in the next lower section (37B) from the universal spline end (44). This position holds the lineman's pole in a configuration that adds strength and rigidity to the end of the lineman's pole where the tool is attached. Accordingly, the lineman has more control over the tool during utility circuit repair.

When extending the lineman's pole out of the tip lock position to its greatest length, the push button assembly (60) is released by depressing the push button (65) and pulling the most distal section (37A) outward. The locking mechanism (75A) and its associated lock button (78A) engage a more proximal surface opening (50B) on the most distal section (37A). In this position, the base ring (76) on the locking mechanism (75) engages a rim (39A) integral with each open end of the pole sections. The base ring (76) and rim (39) engagement plugs the open sections and prevents the sections from detaching upon extension.

As the tip lock position has proven to be more and more useful in circuit repair, the push button assembly (60) is likely to face repetitive use in many linemen's poles. The push button assembly (60), therefore, is prone to break or otherwise require repair due to extreme use. The push button assembly (60) is also subject to destructive forces during normal use. As the lineman uses the tool attached to the lineman's pole, the end of the pole pushes the pole body against the push button assembly. This force is likely to eventually break the push button assembly and require repair.

Repairing the push button assembly, however, is difficult. As noted above, the lineman's poles of the prior art utilize push button assemblies that are not accessible for replacement. The invention herein addresses that problem by making the push button assembly removable from the tip of the lineman's pole that holds the universal spline end (44). The push button assembly (60) is also adapted for inserting into one end of the lineman's pole. Finally, the push button and the push button assembly can be manipulated to numerous positions within the pole by gripping the push button (65) and/or the push button assembly (60) with a tool (e.g., FIG. 5, Ref. 42) that engages an associated connector (80) on the push button assembly (60).

FIG. 5 illustrates the overall push button assembly (60) that accomplishes installation, removal, and adjustment of a push button assembly from an end of the lineman's pole (35) according to this embodiment. As shown in FIG. 5, a portable utility lineman's pole (35) has at least one inner section (37A) and at least one outer section (37B) fitting together in a telescoping configuration. The sections define respective inner section surface openings (50A, 50B) and outer section surface openings (50C, 50D) along the length of the pole (35). To allow for a repair to the push button assembly (65) without requiring disassembly of the entire telescoping lineman's pole, the pole utilizes an accessible push button assembly that can be installed, removed, and moved into position without taking the lineman's pole (35) completely apart.

As noted above, the push button assembly (60) temporarily fixes the length of the pole (35) by holding sections together in the telescoping configuration. A single push button assembly (60), therefore, holds an inner section (37A) of the pole to an outer section (37B) of the pole. The terms inner and outer refer to respective positions of pole sections in an immediate telescoping relationship (i.e., the inner section slides into the outer section). In one embodiment, the push button assembly includes a push button (65) for extending through a surface opening (50A) in the inner section (37A) of the pole and releasably engaging a different surface opening (50C) in the outer section (37B) of the pole. An adapter (70) holds the push button (65) within the inner section surface opening (50A) and allows the push button (65) to be aligned with an outer section surface opening (50C).

In one embodiment, shown by example in the associated drawings, the push button assembly (60) includes an adapter (70) that has a connector (80) either attached thereto or integrally formed in the adapter (70). The connector (80) allows for the push button (65) to be gripped or temporarily attached to a tool (42) for (i) insertion into an open end of one section of the pole, (ii) extraction of a push button assembly that needs to be replaced in the pole, or (iii) positional movement of the push button within the pole. The connector (80) can be any physical or mechanical feature that allows the push button (65) to be gripped by another tool that aids in affixing the push button inside the pole. The connector may be a ring, a tab, a loop, a groove, a slit, a threading, or any other feature that assists in attaching the push button to a tool. One goal of the invention, therefore, is that the connector includes a gripping mechanism, such as threading (80), on the push button (65) and push button assembly (60) to (i) remove the push button from an end of the pole, (ii) control the push button while sliding the push button into an end of the pole, and (iii) rotating the push button into a desired position within the pole. The connector releasably engages a tool for gripping the connector and adjusts the position of the push button into, out of, and within the pole. The connector, therefore, allows the user to manipulate the push button into a fixed position within at least one surface opening in the pole.

One embodiment of the push button (65) and push button assembly (60) includes an adapter (70) defining a threaded hole (80) accessible through an end of the pole (35). The threading (80) serves as the above-described connector for adjusting the push button position. The threading on the adapter matches a corresponding threaded tool (42) that fits down within the end of the lineman's pole and engages the threading in the adapter (70). By attaching the tool to the adapter via the connector, the push button can be placed in a variety of positions within the pole (i.e., to replace a broken push button). For instance, the tool (42) can be used to slide the push button down into one end of the pole. Once the tool is in the pole, the tool and connector are available for rotating the push button (65) until it matches a desired surface opening (50) for use. If a used push button (65) needs to be replaced, by attaching the tool to the adapter (70) and pushing the button inwardly toward the push button assembly (60), the user can pull the entire push button assembly (60) through an end of the lineman's pole. This prevents dismantling every section to replace the push button because the push button is accessible from the closest end.

In yet another embodiment of the invention, a portable utility line pole (35) has inner and outer sections (37A, 37B) made of respective inner and outer hollow members of differently sized cross sections that allow for the inner section to slide within the outer section. The pole sections may be of any convenient shape and size, but are often hollow cylinders that are open at each end. In this embodiment, the adapter (70) of the push button assembly (60) is also a cylindrically-shaped body defining a connector, as described above. The connector may include a threaded recess (80) along at least a portion of the major axis of the adapter (70) body. The above-noted adapter (70) is so dimensioned as to fit within the inner section of the pole such that the major axis of the inner section (37A) and the major axis of the adapter (70) are substantially aligned. The adapter (70) defines an outer bore (74) in which the push button (65) rests for aligning the push button with the appropriate inner section surface opening (50A). The pole is adapted for respectively rotating the inner and outer sections such that the push-button protrudes through the outer bore (74) of the adapter (70), through the inner section opening (50A), and through an outer section opening (50C) to temporarily set the combined length of the inner section (37A) and the outer section (37B) of the pole.

In one embodiment, the push button assembly (60) for setting and releasing a tip lock position of the pole utilizes a spring (63) that fits within the push button (65). The spring biases against the inner section (37A) wall, and the push button (65) incorporates a side opening into which the spring (63) fits. In operation, the spring (63) fits within the push button (65) such that the respective longitudinal axes of the spring (63) and the push button (65) are substantially parallel. The push button and spring slide into a corresponding opening, or outer bore (74), of an adapter (70) having a threading, or threaded recess (80), at one end. The spring (63) may be a separate piece or attached to the adapter (70). As noted above, the threaded opening (80) is one form of a connector used to control the position of the push button. By connecting the adapter (70) to a corresponding threaded tool (42, 43), the push button assembly slides into a distal end of the lineman's pole section farthest from the user. By aligning the push button with an opening (50A) in the most distal section (37A) of the lineman's pole, the spring (63) biases against an inner portion of the distal section (37A) and pushes the push button (65) out of the surface opening (50A) in that distal section (37A). The push button is positioned in a way that allows the user to push the button inwardly against the spring (63) such that the push button surface is flush with the associated surface opening (37A) but will stay engaged with that section for use.

To set up the above-noted “tip lock” position, the user pushes in the second push button (78A) that is part of the usual locking mechanism (75A) as shown in FIG. 7. Then the distal section (37A) of the lineman's pole is allowed to slide downwardly into the next larger telescoping section (37B) (i.e., the fitting lip (76A) slides into the next telescoping section). So long as the alignment indicator (53) is in its appropriate continuous position, the push button (65) that is part of the removable and threaded push button assembly (60) slides into the next larger telescoping section and pops into place within a surface opening (50C) in that next section (37B). The locking mechanism (75A) that previously occupied the surface openings (50B, 50C) slides within the next section (37B), and the second push button (78B) within the locking mechanism (75) engages the interior of the telescoping section (37B) surrounding the most distal section (37A). Of course, in reverse operation, the push button (65) is depressed to an extent that allows the most distal section (37A) to extend outwardly such that the locking mechanism (75) holds the lineman's pole in an extended position.

In the details above, the adapter (70) is part of a push button assembly (60) but the invention also encompasses embodiments in which the push button (65) and the components in the push button assembly (60) are included in a one-piece construction. The connector on the push button allows for greater flexibility in installing, repairing, and maneuvering the push button into an appropriate surface opening. The connector is adapted to attach to an associated tool. The tool and the connector may take many forms. For example, the connector could be a hook, ring or loop, and the tool would include pliers, pinchers, hooks, and the like for engaging the connector. Although the threading on the tool and adapter are shown in the drawings, the threaded embodiment is just one possibility for engaging the tool and the push button assembly. Also, as shown in the drawings, the push button assembly may be held in place via a pin (71) that fits through an associated pin hole (72) in the pole section.

In the specification and drawings, typical embodiments of the invention have been disclosed and, although specific terms have been employed, they have been used in a generic and descriptive sense only and not for purposes of limitation. Different kinds of materials and elements may be substituted for the parts disclosed herein, and any method steps can be adjusted yet still fall within the ambit of the invention. The invention is further set forth in the claims below.

1. A portable utility lineman's pole having at least one inner section and at least one outer section fitting together in a telescoping configuration, wherein the sections define respective inner section surface openings and outer section surface openings along the length of the pole, the pole comprising:
a push button engaging at least one of the sections through at least one surface opening in the section, said push button comprising a connector for adjusting the position of said push button from an end of the lineman's pole.

2. A portable utility lineman's pole according to claim 1, wherein said connector comprises a gripping mechanism for removing said push button from an end of the pole.

3. A portable utility lineman's pole according to claim 1, wherein said connector comprises a gripping mechanism for controlling said push button while sliding said push button into an end of the pole.

4. A portable utility lineman's pole according to claim 1, wherein said connector comprises a gripping mechanism for rotating said push button within the pole.

5. A portable utility lineman's pole according to claim 1, wherein said connector comprises a threading.

6. A portable utility lineman's pole according to claim 1, wherein said connector is selected from the group consisting of a tab, a ring, and a loop.

7. A portable utility lineman's pole according to claim 1, wherein said connector defines an opening for gripping said push button.

8. A portable utility lineman's pole according to claim 1, wherein said connector releasably engages a tool for gripping said connector and adjusting the position of said push button through an end of the lineman's pole.

9. A portable utility lineman's pole according to claim 8, wherein the tool holds the push button via said connector for manipulating the push button into a fixed position within at least one surface opening.

10. A portable utility lineman's pole having at least one inner section and at least one outer section fitting together in a telescoping configuration, wherein the sections define respective inner section surface openings and outer section surface openings along the length of the pole, the pole comprising:
at least one push button assembly for temporarily fixing the length of the pole by holding the sections together in the telescoping configuration, said push button assembly comprising:
a push button for extending through an inner section surface opening and releasably engaging an outer section surface opening;
an adapter for holding the push button within an inner section surface opening and allowing the push button to be aligned with an outer section surface opening; and
a connector on said adapter for engaging said push button assembly.

11. A portable utility lineman's pole according to claim 10, wherein said connector comprises a gripping mechanism for removing said push button from an end of the pole.

12. A portable utility lineman's pole according to claim 10, wherein said connector comprises a gripping mechanism for controlling said push button assembly while sliding said push button into an end of the pole.

13. A portable utility lineman's pole according to claim 10, wherein said connector comprises a gripping mechanism for rotating said push button assembly within the pole.

14. A portable utility lineman's pole according to claim 10, wherein said connector comprises a threading.

15. A portable utility lineman's pole according to claim 10, wherein said connector is selected from the group consisting of a tab, a ring, and a loop.

16. A portable utility lineman's pole according to claim 10, wherein said connector defines an opening for gripping said push button.

17. A portable utility lineman's pole according to claim 10, wherein said connector releasably engages a tool for gripping said connector and adjusting the position of said push button through an end of the lineman's pole.

18. A portable utility lineman's pole according to claim 10, further comprising a universal spline end connected to a first end of the pole.

19. A portable utility lineman's pole according to claim 18, wherein said universal spline end comprises dual bores with a respective bore on opposite sides of the universal spline end.

20. A portable utility lineman's pole according to claim 10, wherein said adapter comprises a substantially cylindrically-shaped body defining said connector as a threaded recess along at least a portion of the major axis of the body.

21. A portable utility lineman's pole according to claim 20, wherein:
the inner and outer sections of the pole comprise respective inner and outer hollow cylinders of different diameters that allow for the inner section to slide within the outer section; and
said adapter is so dimensioned as to fit within the inner section of the pole such that the major axis of the inner section and the major axis of the adapter are substantially parallel.

22. A portable utility lineman's pole according to claim 20, wherein said cylindrically shaped body of said adapter defines an outer bore for aligning with the inner section opening.

23. A portable utility lineman's pole according to claim 10, wherein said push button comprises a hollow body, and said push button assembly further comprises a spring fitting within said hollow body of said push button.

24. A portable utility lineman's pole according to claim 23, wherein said spring is detachable from said push button.

25. A portable utility lineman's pole according to claim 10, wherein:
the inner and outer sections of the pole comprise respective inner and outer hollow members of differently sized cross sections that allow for the inner section to slide within the outer section;
said adapter is so dimensioned as to fit within the inner section of the pole such that the major axis of the inner section and the major axis of said adapter are substantially aligned;
said adapter defines an outer bore in which the push button rests for aligning the push button with the inner section opening; and
the pole is adapted for respectively rotating the inner and outer sections such that said push-button protrudes through the outer bore of the adapter, through the inner section opening, and through the outer section opening to temporarily set the combined length of the inner section and the outer section of the pole.

26. A portable utility lineman's pole according to claim 10, wherein the inner and outer sections of the pole comprise respective inner and outer hollow members, each hollow member having open ends providing access to the interior of the hollow members, the pole further comprising:
a locking mechanism that fits within an open end of the inner section, said locking mechanism comprising:
a lock button for extending through a second opening on the surface of the inner section and releasably engaging a corresponding opening on the surface of the outer section; and
a base ring around one end of said locking mechanism for engaging an open end of both the inner and outer sections, thereby holding the locking mechanism in place during use.

27. A portable utility lineman's pole according to claim 26, wherein each section of the pole has a proximal end and a distal end in relation to a person using the pole and wherein said base ring around said locking mechanism engages an open proximal end of the inner section, and said locking mechanism also engages an open distal end of the outer section.

28. A portable utility lineman's pole according to claim 27, wherein the open proximal end and the open distal end of the sections comprise respective rims, said rims engaging the fitting lip on said locking mechanism.

29. A portable utility lineman's pole according to claim 26, wherein the corresponding opening on the surface of the outer section releasably engages either of the push button or the lock button by telescoping the inner and outer sections of the pole.

30. A portable utility lineman's pole according to claim 26, comprising at least one additional section, said additional section comprising an additional locking mechanism and inner edges defining two additional surface openings at opposite ends of said additional section.

31. A portable utility lineman's pole according to claim 10, further comprising a tool for engaging said connector through an end of the inner section, such that depressing said push button and engaging said connector with the tool allows for removal of said push button assembly from the inner section.

32. A portable utility lineman's pole according to claim 10, wherein the inner section comprises a locking mechanism and said outer section comprises a corresponding opening for engaging either said push button assembly or said locking mechanism.

33. A portable utility lineman's pole according to claim 10, wherein the inner section opening and the outer section opening are positioned along respective visible lines on the inner section and the outer section.

34. A portable utility lineman's pole and tool combination for maneuvering a push button assembly within the lineman's pole, the combination comprising:
at least one inner pole section and at least one outer pole section fitting together in a telescoping configuration, wherein the sections define respective inner section openings and outer section openings along the length of the pole;
a push button for extending through an inner section opening and releasably engaging an outer section opening;
an adapter for holding said push button within said inner pole section,
a connector attached to said adapter, wherein said connector is accessible through an end of the inner section; and
a tool that engages said connector to adjust the position of said adapter and said push button through one end of said inner section.

35. A portable utility lineman's pole and tool combination according to claim 34, wherein said connector is selected from the group consisting of a tab, a ring, and a loop.

36. A portable utility lineman's pole and tool combination according to claim 35, wherein said connector is a threading and said tool is adapted to engage said threading.

37. A portable utility lineman's pole according to claim 34, wherein said connector comprises a gripping mechanism for removing said push button from an end of the pole.

38. A portable utility lineman's pole according to claim 34, wherein said connector comprises a gripping mechanism for controlling said push button while sliding said push button into an end of the pole.

39. A portable utility lineman's pole according to claim 34, wherein said connector comprises a gripping mechanism for rotating said push button within the pole.

40. A portable utility lineman's pole according to claim 34, the inner and outer sections of the pole comprise respective inner and outer hollow cylinders of different diameters that allow for the inner section to slide within the outer section; and
said adapter is so dimensioned as to fit within the inner section of the pole such that the major axis of the inner section and the major axis of the adapter are substantially parallel.

41. A portable utility lineman's pole according to claim 40, wherein said adapter defines an outer bore for aligning with the inner section opening.

42. A portable utility lineman's pole according to claim 40, wherein said push button comprises a hollow body, and said push button assembly further comprises a spring fitting within said hollow body of said push button.
